(19) United States
(12) Patent Application Publication
(10) Pub. No.: US 2011/0224999 A1
(43) Pub. Date: Sep. 15, 2011

(54) System and method for providing online fitness instruction

(76) Inventor: Nancy Baccarella-Garcia, Mt. Olive, NJ (US)

(21) Appl. No.: 12/659,496

(22) Filed: Mar. 11, 2010

(51) Int. Cl. G06Q 50/00; G06F 3/00; G06Q 20/00; G06Q 99/00; G06Q 30/00; H04N 7/14

(52) U.S. Cl. 705/2; 705/319; 348/14.08; 715/758; 348/E07.077

(57) ABSTRACT

The member-accessible internet site acts a hub for gyms from various locations to host their fitness classes live in either a one-way or two-way feed. A member-accessible internet site provides live one-way, and optional two-way, feeds to multiple live exercise classes being conducted at various remote gym facilities. In the one-way embodiment, the participating member would see the exercise instructor and optionally all or part of the on-site exercise group, but he/she would not be visible to them. In the two-way embodiment, the online participants would also be visible to the instructor on a screen display, which will enable the instructor to critique and correct the exercise technique of the online participants. Other features of the invention include, but are not limited to, online communication capabilities such as instant messaging between members, online groups according to interests and age, one-on-one personal training, articles relating to health and fitness, information about instructors and classes, class schedules, discussion boards to rate different classes, and an initial evaluation survey to determine the appropriate type and level of exercise program for each participant.

### BACKGROUND OF THE INVENTION

The present invention relates to the field of systems and methods for providing information and services pertaining to health and fitness. More particularly, the present invention relates to web-based applications that provide interactive access to classes and instruction pertaining to health and fitness.

IJustWannaBeFit.com (IJWBF) is a web-based business that provides live exercise classes that users can view and participate in from any internet connection. Logging onto to the site, users have the option to choose from a variety of live fitness classes being streamed live throughout the day, from all over the world.

Many people who exercise share several common characteristics: the need for some level of social interaction to keep the exercise effort both interesting and motivating, attachment with a particular routine or instructor, and convenience. The combination of these three factors is important to many of those who exercise—and many of those who don't. IJWBF was created to satisfy the convergence of fitness and well being with the trend toward online social interaction.

IJWBF is a web-based business that provides social networking along with live exercise classes, one-on-one virtual training, nutrition coaching, and health and wellness information. The live classes offered have both one-way and optional two-way interactive capabilities. The goal is to provide an interactive, live website that will help millions of people achieve a functional fitness level in a fun, social, and unique way.

The mission of the business methodology of the present invention is simple: To help as many people as possible achieve and maintain a healthy lifestyle through exercise, nutrition, and the mind-body connection and to do all this in a very affordable and user-friendly way. This mission is accomplished by providing live video feeds of a variety of different exercise classes originating from multiple gyms throughout the U.S. and the world. Until recent years, the technology of sending live video feeds through the internet was too costly and not yet reliable. But with advances in video streaming technology and the widespread availability of broadband internet connections, the ability to provide live interactive access to numerous exercise fitness facilities has become a reality.

Some existing websites, such as yogaglo.com, laonlinefitness.com, and liveworkout.tv, offer live one-way workout video steams, but these are limited to viewing workout sessions from a single studio or gym. Currently no site exists that serves as a hub for various live fitness sessions originating from different studios and gyms, with multiple live feeds from different locations. Therefore, the IJWBF business model is unique.

The present invention provides a member-accessible internet site which provides live one-way, and optional two-way, feeds to multiple live exercise classes being conducted at various remote gym facilities. In the one-way embodiment, the participating member would see the exercise instructor and optionally all or part of the on-site exercise group, but he/she would not be visible to them. In the two-way embodiment, the online participants would also be visible to the instructor on a screen or monitor, which will enable the instructor to critique and correct the exercise technique of the online participants. Other features of the invention include, but are not limited to, online communication capabilities such as instant messaging between members, online groups according to interests and age, one-on-one personal training, articles relating to health and fitness, information about instructors and classes, class schedules, discussion boards to rate different classes, and an initial evaluation survey to determine the appropriate type and level of exercise program for each participant. Participating gyms could have the opportunity to share in member fees and be able to advertise on the site.

The U.S. patent application of Daikeler et al., Pub. No. US 2005/0192156, describes a method for creating a virtual online gym referred to as the “Work Out With You” (WOWY) system. Members can join one or more WOWY Workout Groups and see who else in their group is working out at the same time. After completing their workout, they can chat with their workout buddies in a virtual Cool Down Chat Room. While the WOWY system has certain features in common with the present invention, it does not provide access to live exercise classes. Members choose from a list of pre-recorded exercise classes and exercise videos. While the component modules of the exercise programs may be dynamically changed as the members progress in their fitness regimen, there is no real-time interaction except among the participating members of the virtual classes.

The U.S. patent application of Singh, Pub. No. US 2006/0184427, also describes an internet-based exercise program which allows users to select from a database of pre-recorded exercise videos. The videos can be either previously recorded live exercise classes or a recording of an instructor going through an exercise routine. There is no real-time interactive component, not even the limited “buddy” interaction of the WOWY system.

A second U.S. patent application of Singh is a continuation-in-part of the application discussed above, US 2007/0005395. In the latter application, the internet exercise program is expanded to include an “online gym.” In one embodiment, the online gym can be used by local health clubs to routinely video tape all their exercise classes and make them available via the internet. Again, however, all exercise classes are pre-recorded, and there is no real-time interactive component.

The patent application of Piccionelli et al., Pub. No. US 2008/0242514, describes an internet-based fitness coaching system. A user accesses the system while at the physical location of the selected fitness activity. Therefore, this is not a “virtual gym” or “online gym,” as in the WOWY and Singh applications. And, unlike those systems, the Piccionelli system provides real-time interaction between the “e-coach” and user. In one embodiment, the physical exercise apparatus on which the user is working is provided with a video camera, which enables a professional trainer to observe the user's performance over the internet and provide real-time e-coaching. Since the Piccionelli system requires the user to actually go to a gym or exercise club, it's different from the IJWBF system, which enables the user to participate in real-time from any internet connection, including but not limited to a home or office. There's also no obvious way of combining the Piccionelli system with the “virtual gym” prior art, which are based on the convenience of 24/7 availability of pre-recorded workout classes.

The U.S. patent application of Mensah et al., US 2009/0047644, describes a multimedia system for producing customized fitness programs through an internet site. This is another “virtual gym” type system, but it's different from the WOWY and Singh systems insofar as it's not limited to pre-recorded exercise tapes. The Mensah system generates a virtual instructor “avatar” based on user inputs. The “avatar” is merged with instructional files selected by the user from a database so that the avatar appears to perform the desired exercise routines. There are no features of real-time interaction between the avatar and the user, so that the end result is similar to a pre-recorded exercise video, albeit one customized to a user's preferences.

Unlike the prior art, the present invention is able to recreate, at a remote location, the experience of actually participating in a live fitness class. The experience includes the ability to interact on a real-time basis with the instructor and other class participants. And, since the IJWBF website serves as a hub for numerous live video streams from fitness classes throughout the day and night, online participants are free to choose not only the type of classes that best suit their needs, but the days and times when working out is most convenient for them.

For hosting fitness facilities, the IJWBF business method provides a highly innovative and professional tool to increase exposure, create branding, and derive additional revenue. For fitness instructors and trainers, the IJWBF system can increase income and offer promotional benefits.

### SUMMARY OF THE INVENTION

IJWBF is a web-based fitness hub that provides video streams of multiple live exercise classes, originating in multiple fitness facilities, along with one-on-one virtual training, and health and wellness information.

Interactive internet access to multiple live exercise classes is the core element of the present invention. This is a new methodology. Few websites host live exercise classes, and those that do originate from a single fitness studio. Many websites have videos, but videos are not interactive. Live classes are interactive. Optionally, online members who participate remotely in live classes can turn their webcams on too. This means the instructor and other class members can see people who are taking the class via the web.

The present invention also simulates the social environment of a live exercise class. This draws upon the expanding social networking capabilities of the internet. Being in a live class is much more social than watching a video. Members will be logged into the class, and member names will be listed on the website so members can check and see if their friends are taking the class. Also, the members who are taking the class can opt to go into private chat rooms while the class is in progress, so they can chat with their friends privately during the class. Members are also able to enter the chat rooms before or after a class.

As live fitness classes are taking place around the globe, simple web cameras connected to the internet will stream the class onto the IJWBF site. Categorized on a dynamic schedule by type, level, duration, and time, live classes will be available throughout the day for members to choose from. In one embodiment of the IJWBF site, membership to the site will be free, but each class will cost members a fee per class. Alternately, membership fees for unlimited access to classes can be assessed on a periodic basis, such as monthly. In another embodiment of the IJWBF site, class participation would be free, and all revenue would be generated by selling advertising on the site. The hosting gyms where the classes will be filmed will pay for and maintain the on-site video equipment which is expected to cost between $50 and $250, depending on the whether they already have a computer available and the quality of the web camera they purchase.

Participating hosting gyms will require a computer and a webcam. All virtual exercise teachers and personal trainers will also need a computer and webcam, and in some instances web conferencing equipment. IJWBF members will need a computer, and for two way feeds they will also need a webcam.

Instructors and gyms will be motivated to join the IJWBF network. Currently, fitness instructors are paid $30-$50 for a one hour class. By teaching online live classes using IJWBF, instructors can increase their earnings while working the same amount of time. In turn, instructors will be motivated to teach high quality classes so that more online members sign-up for their classes. Everyone wins by increased revenues: gyms, instructors and IJWBF. The advantages for gyms to utilize IJWBF can include increased revenues without added overhead, increased publicity, advertising, and branding.

Gyms have high attrition rates (average of 40%), which can put them out of business unless new members are continuously brought in, so by hosting classes, gyms may gain new members who are taking the class and reside locally. Selling a membership to someone is far easier to do when he/she has seen and participated in an actual class and feels less apprehensive about the gym environment. Also, some people want to get into shape before joining the gym. Potential local members would take classes from home until they felt they were fit enough to enter the gym. For those gyms that want to expand regionally or nationally, IJWBF can provide the venue for increases exposure and branding. The incentives for hosting a good class are in place. Classes that are generating a lot of interest will be perceived as a higher quality and reflect positively on both the instructor and hosting facility.

In addition to serving as hub for a variety of fitness classes throughout the world, IJBWF will also provide a social networking platform from which members can communicate with each other (and with instructors) using instant messaging, chat rooms, and blogs. For many people who work out, the social interaction and the camaraderie that is established is a key motivating factor to staying fit. The dynamics of the social element of IJWBF recreates the dynamics that occur in person at the gym. In gyms class participants become attached to their favorite instructors, which naturally generates camaraderie, trust, and loyalty. Instructors will find all of those elements occurring with remote participants as well. Additionally, a social nexus is created in the gym between members. Loyal participants in an exercise class keep tabs on each other and are informed when and why a fellow loyal participant is missing a class. Coming to the same class at the same time with the same people builds a community within the class. That community will be enhanced and expanded through IJWBF. Thus, the online social networking platform is a key component of the IJWBF business model.

Along with hosting facilities, advertisers of fitness goods and services will be able to purchase advertising space on the IJWBF site. The IJWBF site and associated members will be an important target market comprising mostly women between the ages of 18-40. With the site established an in place, many advertisers, such as national fitness chains and home exercise equipment companies, will be motivated to advertise on the IJWBF site and thereby gain access to an ideal target audience.

The IJWBF business will be internet based, while the hardware (cameras, computers, etc.) will be located in gyms and other fitness facilities. Although IJWBF will provide recommendations, fitness facilities will provide their own equipment that is connected to the internet. IJWBF will allow certified exercise professionals to connect to the website and make their class available to members.

### BRIEF DESCRIPTION OF THE DRAWINGS

FIGS. 1-8 are tables which describe the functional structure of the preferred embodiment of the IJWBF website.

FIG. 1 is a table describing the different user levels and the capabilities and module access pertaining to each.

FIG. 2 is a table describing the functions of the User Module and the Content Management Module.

FIG. 3 is a table describing the functions of the Text Chat Module, the Video Streaming Module, and the Class Module.

FIG. 4 is a table describing the functions of the Blog Module, the Twit Module, and the Payment Module.

FIG. 5 is a table describing the functions of the Calendar Module and the Trainer Module.

FIG. 6 is a table describing the functions of the Messaging Module and the Club Module.

FIG. 7 is a table describing the functions of the Workshop Module, the Nutrition Section Module, and the Search Module.

FIG. 8 is a table describing the Alternative Health Module and the Software Architecture and Design.

FIG. 9 is a schematic diagram illustrating an exemplary one-way real-time streaming of multiple live exercise classes to IJWBF members via the internet.

### DETAILED DESCRIPTION OF THE PREFERRED EMBODIMENT

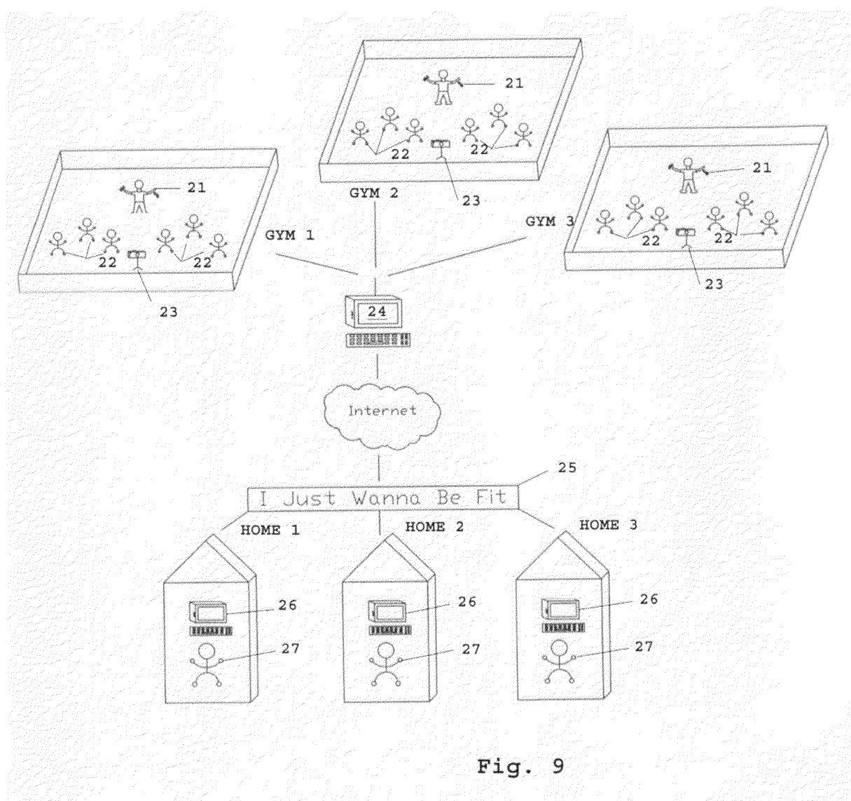

As illustrated in FIG. 9, the present invention provides a member-accessible internet site 25 which provides live one-way, and optional two-way, feeds to multiple live exercise classes being conducted at various remote gym facilities. The remote gym facilities will each be equipped with on-site video and computer equipment 23 to stream the live exercise classes to the IJWBF server computer 24. In the one-way embodiment, the participating member 27, using their home computer equipment 26, would see the exercise instructor 21 and optionally all or part of the on-site exercise group 22, but he/she would not be visible to them. In the two-way embodiment, the online participants 27 would also be visible to the instructor 21 in a video display, which will enable the instructor 21 to critique and correct the exercise technique of the online participants 27. Other features of the invention include discussion boards to rate different classes and an initial evaluation survey to determine the appropriate type and level of exercise program for each participant. Participating gyms could have the opportunity to share in member fees and be able to advertise on the site.

In the preferred embodiment of the IJWBF website, there will be 11 areas of interest to click on:
1. Member area. This area will have the sign up information to become a member. The member area will be interactive with chat rooms, member information, and message boards. It will have an area to track the member's fitness goals, eating habits, etc. It will be similar to the member area of Popsugar.com
2. Fitness Training. This area will focus on exercise. Exercise classes with be live and interactive. Members can pay a fee to join group exercise classes, such as kickboxing, spin, step aerobics, pilates, and yoga. Members will also be able to pay for a virtual personal trainer. They will have the option to sign up for ½-1 hour session with a personal trainer for a fee. This section will also include “Exercise Tips” and “Ways to Stay Healthy.” It will also have a “Find a Trainer in Your Area” section, if people prefer to have someone come to their home and train them in person.
3. Nutrition. This area will focus on nutrition and healthy eating habits. For an extra fee, members join the nutrition program and get a detailed analysis of their diet. They can also sign up for a personal consult with the site's nutrition coach for an extra fee.
4. TwoT's Area. This area if for the twenty and thirty year olds. This section will include articles, blogs and messaging features for this age group.
5. Life at Forty and Up. This area is all about living life at 40, 50, and 60 and up. There will be articles, blogs and messaging capabilities about mature life in general.

6. FitTeens Section. This is for teenagers who want to IM each other, blog about ideas, or just socialize with other teens.
7. IJustGotFit -Success Stories. This area is all about the members and the successes they want to share. Whether it's fitness or life success stories, this will be the place on the site that will encourage IJWBF members to share things about their lives with other members.
8. The Over 250 Club. This area is for people who are over 250 lbs or people who have been over 250 lbs and lost weight. The goal in this section is for camaraderie to build with people who have similar weight loss goals. People who have been successful can encourage others to lose weight and live a healthy lifestyle.
9. Workshops. This area will list workshops related to fitness and health. The workshops will be sponsored by other organizations, but the goal is to get the information to the IJWBF member so they can choose to attend a workshop to improve their overall health. Workshops are ongoing throughout the country, but many individuals might not know where to look or who can attend the fitness workshops.
10. Alternative Health. This area will focus on alternative health modalities and alternative health products. Members will have the opportunity to be interactive within this area. For example, the site may post an article about therapeutic uses of magnets and then ask members to enter their feedback about using magnet therapy.
11. IJustWannaBeFit Retreat. Once the business is established, the fitness instructors who are pulling in the most users will be invited to teach their classes at a 3 day IJustWannaBeFit retreat. The retreat will focus on fitness, healthy eating and stress management. Cooking classes, fitness classes, and mind-body connection classes will be offered at the retreat. This area will offer information, photos and comments regarding past and upcoming retreats.
12. Where Do I Start????? This will be a question and answer form designed to help people who don't know where to start with their fitness regime. The questionnaire will point users in the right direction with regard to which classes they would be best suited to try. Not every member will use this; this is merely for the users who really don't have any idea of where to begin their journey towards health and fitness.

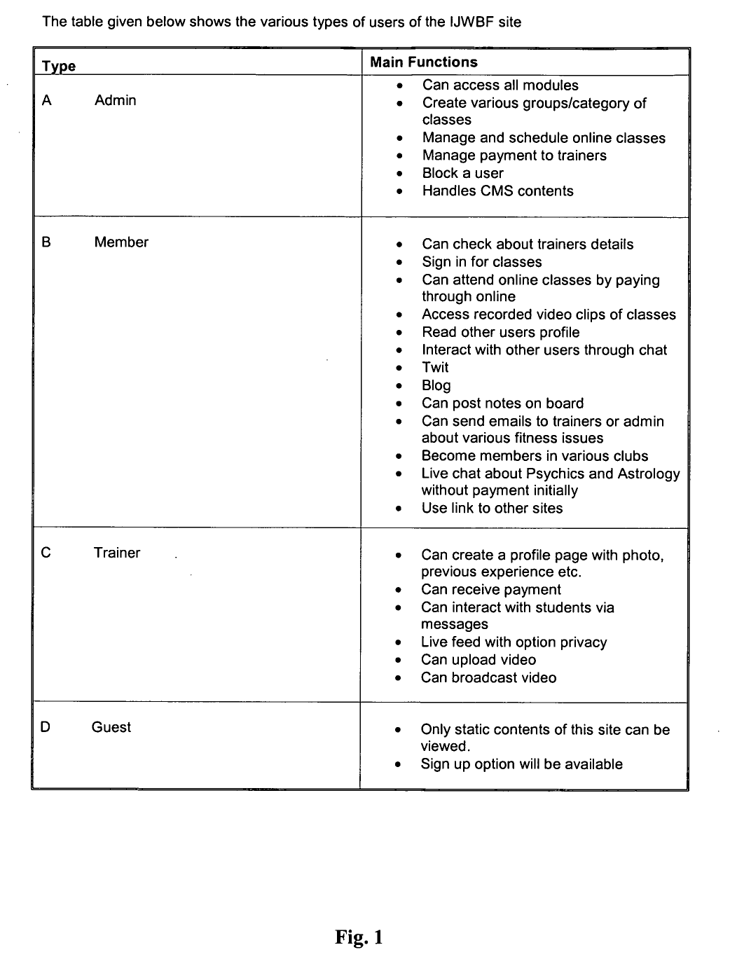

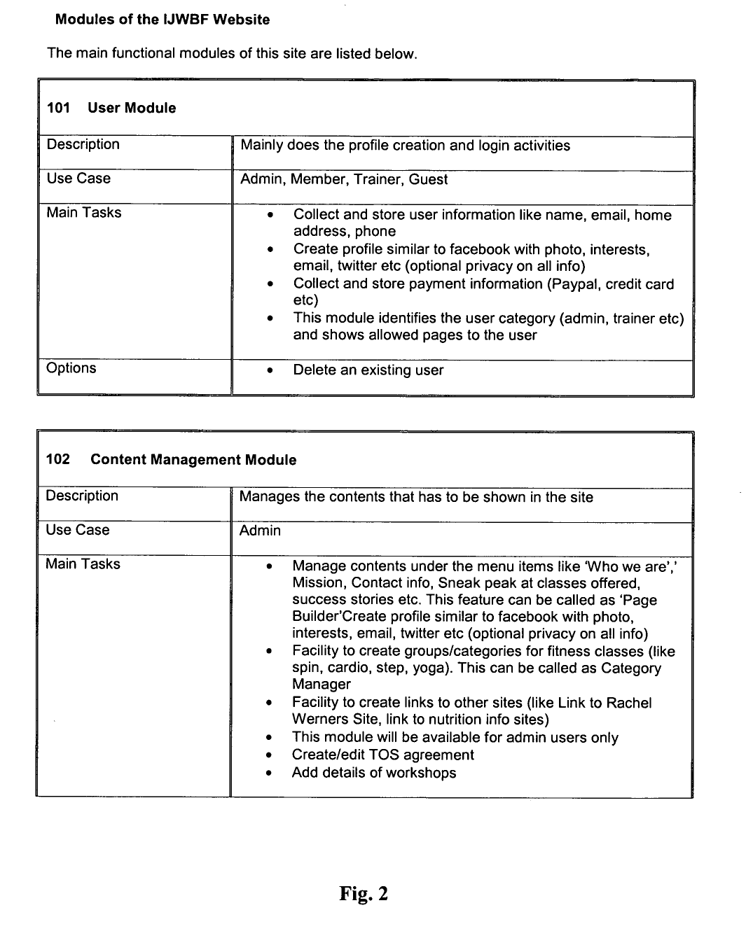

Structurally, the preferred embodiment of the IJWBF website has an architecture comprising a series of functional modules, as described in FIGS. 2-8. Exemplary access permissions for the four User categories—Administrators, Members, Trainers and Guests—are described in FIG. 1. The illustrative site architecture for the preferred embodiment, as described in FIG. 2, includes a User Module 101 and a Content Management Module 102. The User Module 101 creates Member profiles, enables Member login, and control access according to the User category.

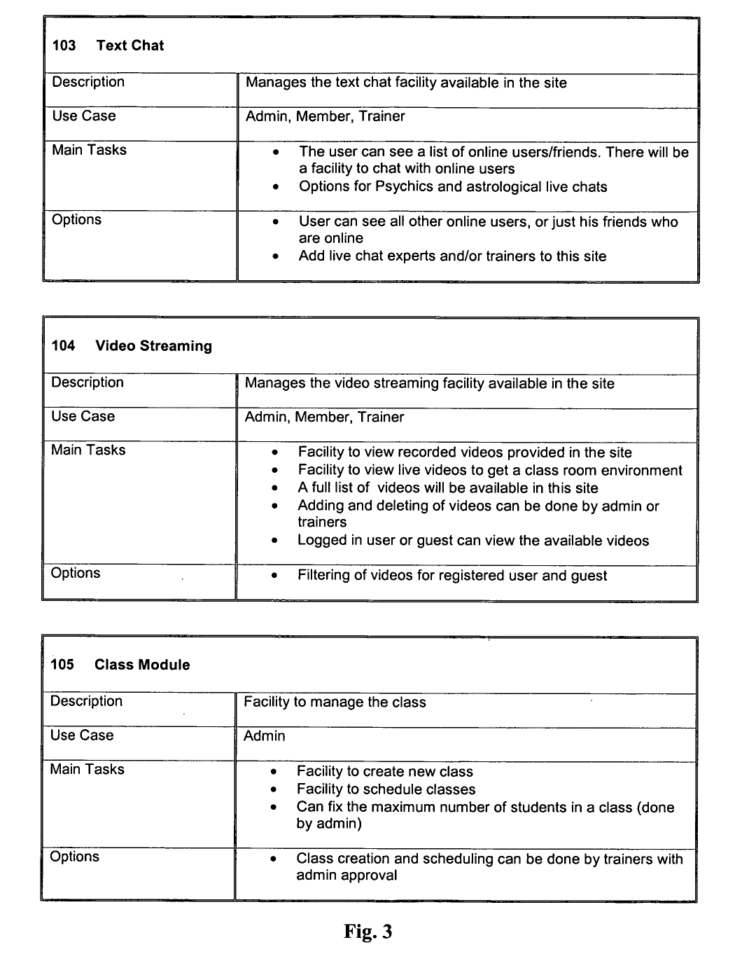

The illustrative site architecture, as further described in FIG. 3, also includes a Text Chat Module 103, a Video Streaming Module 104, and a Class Module 105. The Text Chat Module 103 enables Users to engage in live online text chat with fellow Members, Trainers, or experts. The Video Streaming Module 104 manages the live and prerecorded video content streaming from the site, which can be accessed by the User from a menu of available live and prerecorded video content. The Class Module 105 is used by site Administrators to create and schedule live fitness classes and, if appropriate, establish a maximum enrollment per class.

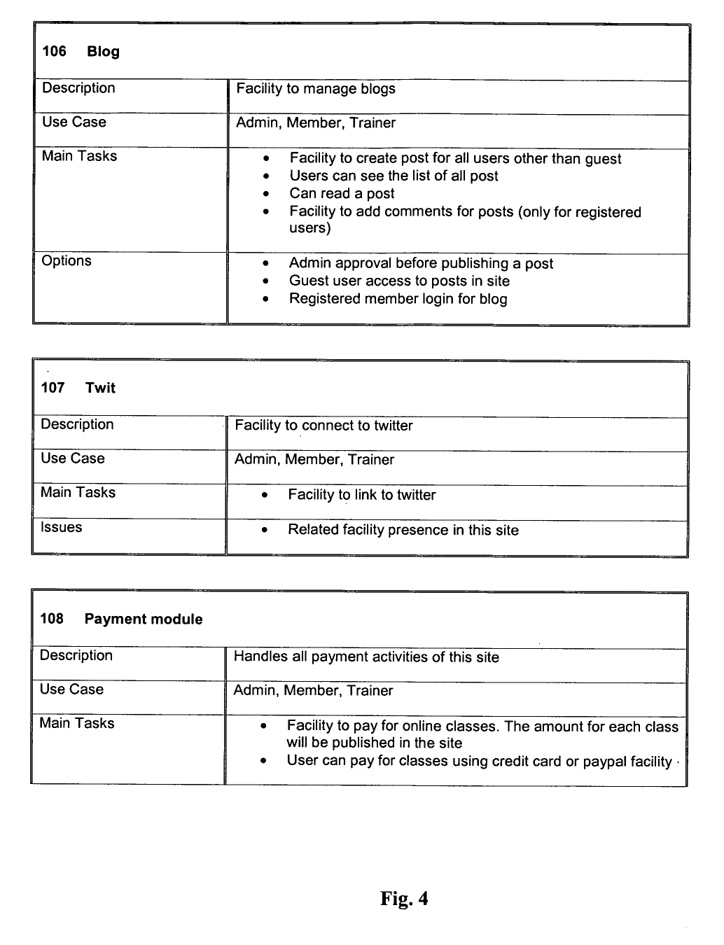

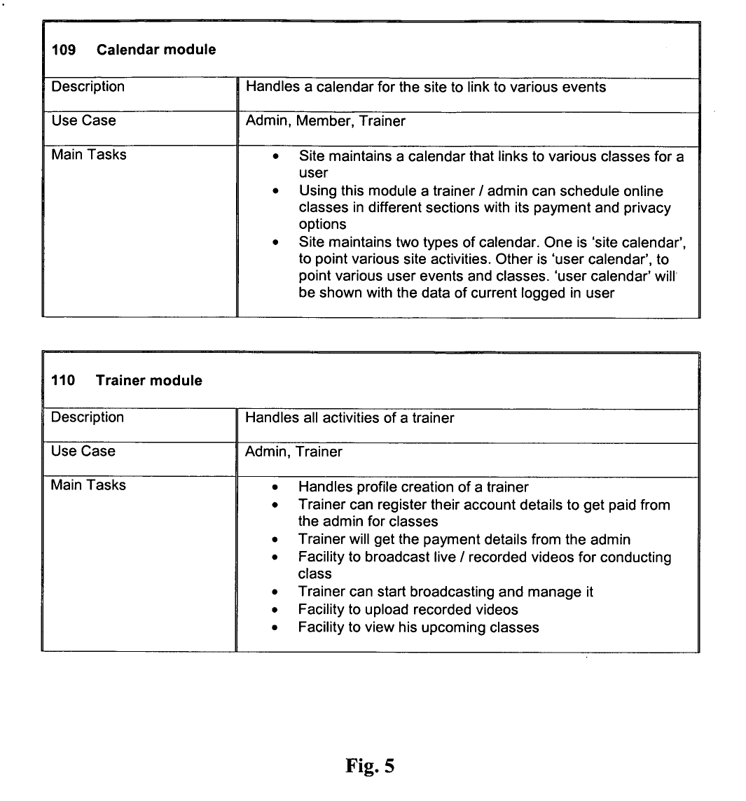

As further described in FIG. 4, the exemplary site architecture of the preferred embodiment also includes a Blog Module 106 and a Twit Module 107, for managing blogs and connection to Twitter, respectively, as well as Payment Module 108. The latter handles all payment activities of the site, including Member payments for online classes. As further illustrated in FIG. 5, exemplary site architecture also includes a Calendar Module 109, which maintains a calendar linked to descriptions of various classes offered on given dates/times, and a Trainer Module 110, which handles all trainer-related activities, such as profiles, payment for classes, upcoming classes, etc.

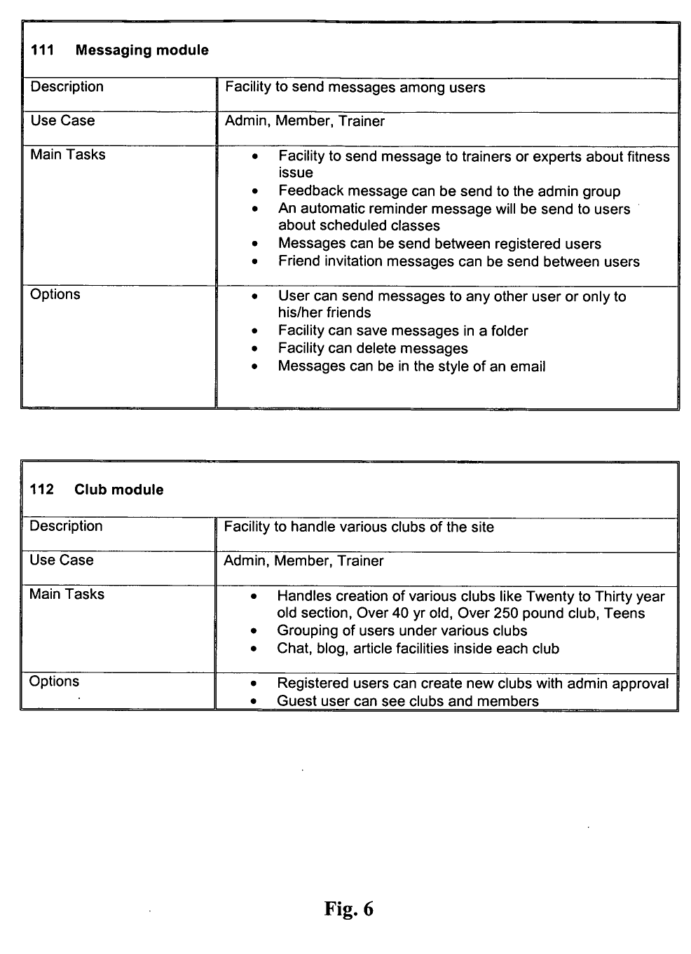

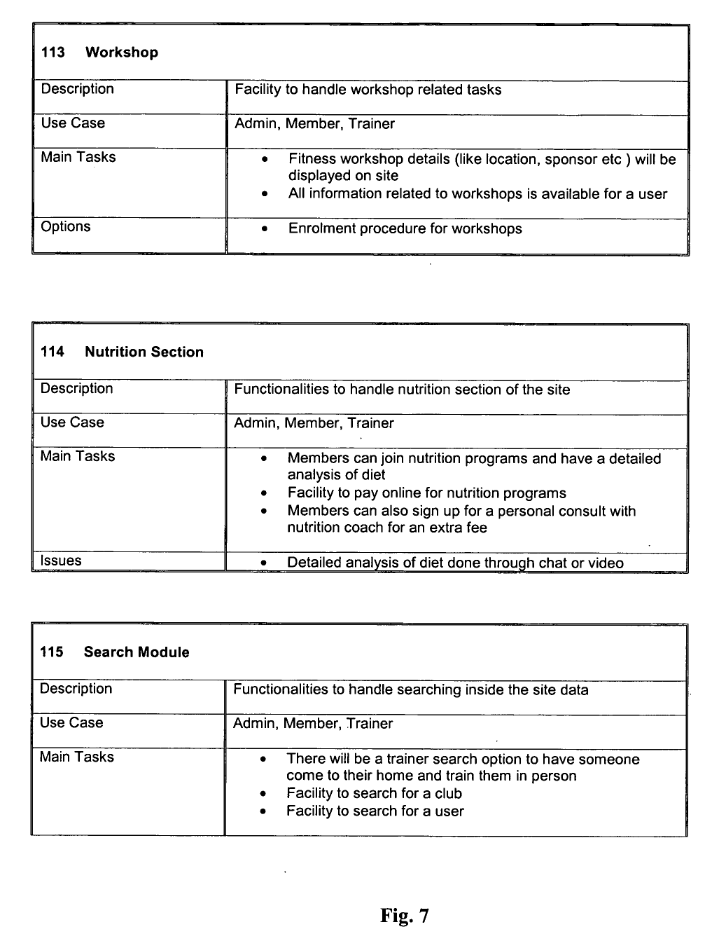

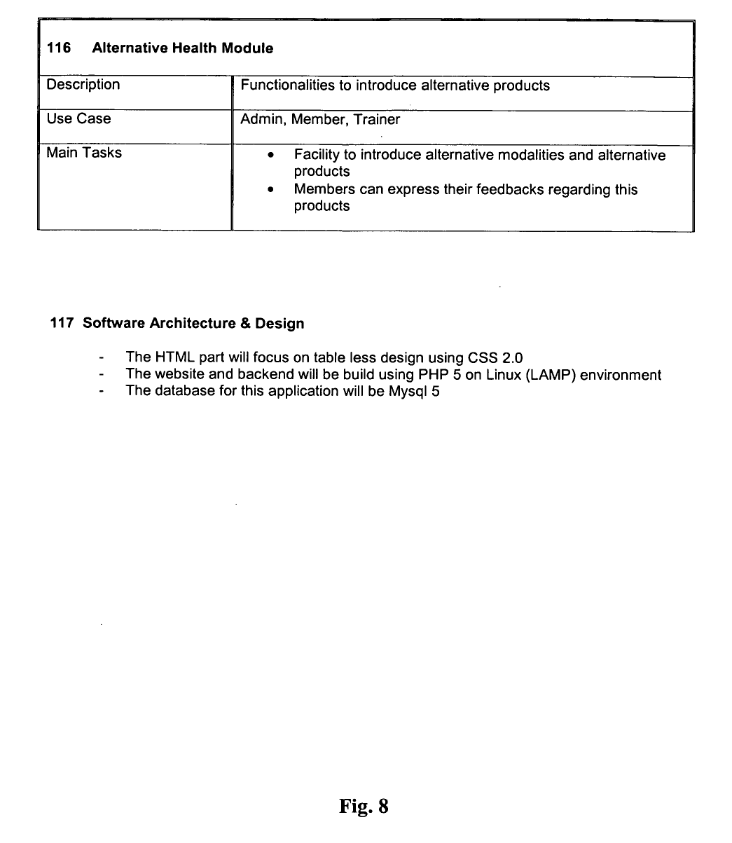

As described in FIG. 6, a Messaging Module 111 handles messaging between registered Users, while a Club Module 112 enables creation of various clubs and participation of Members in these clubs. FIG. 7 outlines the functions of the Workshop Module 113, Nutrition Section Module 114, and Search Module 115. FIG. 8 gives the functions of the Alternative Health Module 116, and also sets forth exemplary software design features for the site.

Illustrative web pages of the preferred embodiment of the IJWBF site include:

Main IJWBF Page:
Who we are
Mission
Contact info
Sneak peak at classes offered
Success stories
Login

Login: Membership is free.
Name (can be real or screen name)
Email address
Home address
Phone
User profile similar to Facebook—photo, interests, any info they want public like email, Twitter, Facebook etc., classes in which they are participating (optional privacy on all info)
Fitness Goals
Terms of Service (TOS) Agreement
Payment information (Paypal, credit card etc)
Text message reminder for class

Member Area
Chat area
Sign in for classes
Pay for classes
Twitter
Blog
See who is online
Read friends' profiles
Message board to post notes
Where Do I start? A questionnaire to help people figure out what classes to take
Area to track fitness goals (can publish on profile)

Fitness Section
Calendar Main that links to each class in the next category
Fitness Classes
Group Fitness Classes—all classes listed by type of class
   1. Spin
   2. Cardio
   3. Step
   4. Yoga
   5. Pilates
   6. Tai chi
   7. Fit and tone
   8. Abs
   9. Kickboxing
   10. Les Mills classes (there are 4 types of Les Mills Classes)
   11. Teen Fit
   12. Dance
   13. Meditation
   14. Boot Camp
   15. Core
   16. 30 minute workout
   17. Famous Guru classes (a surcharge applies when applicable)
Each class will have a schedule for that area, sign up section, payment and privacy option
Payment Links to Live Feed
Live Feed
Instructor Bio page—this page will have their optional photo/bio/website link etc. This page must link to the class in the Class area.
Personal Training
   1. Trainer Bio Page—each trainer has his own page with photo, bio, payment and scheduling info
   2. Payment
   3. Live Feed with option of privacy
Live Feed

IJustWannaBeFit.com will have free membership. Members will pay a fee for each exercise class they participate in, or a flat monthly fee for unlimited access. Corporations may also want to buy live classes for employees to participate in before work, during lunch, or after work. IJWBF can design special fees for corporations who have many employees taking one class. A portion of revenues will come from advertisers who will market their products and services on the IJWBF website. IJWBF can either sell web space directly to advertisers or lease space to web advertising companies.

Gyms and other exercise facilities will be motivated to participate because of the ability to realize increased exposure which they could not attain on their own, as well as the potential to increase revenues significantly by sharing in member fees. Other than gaining exposure from being a participating facility on the site, each instructor will plug the facility that hosts their class in an effort to accentuate the facility. Eventually, when people are shopping around for a gym to join, they can come to IJustWannaBeFit.com and virtually check out the gym by taking a few live classes. So, people can decide before they step into a gym which gym they want to join in their area. It will be much easier for the gym to sell memberships to customers who have already participated in on-line live classes. Also, out of the 20,000 gyms in the US, over 18,000 are small businesses, which means that IJWBF can also help small gyms gain national recognition and branding if the gym provides excellent instruction.

Potential advertisers on the site include any company who wants to target the 18-35 year old market, and any company whose products or services are related to health and fitness. Specific fitness companies would advertise along with holistic health companies, all-natural and organic companies, fitness apparel, sports equipment and apparel and music. Other companies not related to fitness, but who want to focus on the 18-35 year old market would also advertise their products and services. The range and possibilities for advertisers is endless.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. An website accessible to persons having computer access to the internet, wherein the persons can become participating members of the website, and wherein participating members, upon payment of a fee, can engage in interactive real-time participation in any one of multiple live exercise classes through streaming video feeds originating from multiple participating facilities, at each of which participating facilities the exercise classes are being conducted by an on-site exercise instructor.

2. The website according to claim 1, wherein the streaming video is in a one-way mode, such that each participating member would see the on-site exercise instructor, but the participating member would not be visible to the on-site instructor.

3. The website according to claim 1, wherein the streaming video is in a two-way mode, such that each participating member would see the on-site exercise instructor, and each participating member would be visible to the on-site instructor on a video display, thereby enabling the on-site exercise instructor to critique and correct the exercise technique of each participating member.

4. The website according to any one of claims 1 through 3, wherein a portion of the fee paid by each of the participating members for participation in one of the exercise classes is paid to the participating facility from which the video feed of the exercise class originates and/or to the onsite exercise instructor.

5. The website according to any one of claims 1 through 3, wherein each participating members can use the website to communicate with other participating members through message boards, web blogs, text messaging, Twitter-type pages, and/or Facebook-type pages.

6. The website according to claim 4, wherein each participating members can use the website to communicate with other participating members through message boards, web blogs, text messaging, Twitter-type pages, and/or Facebook-type pages.

7. The website according to any one of claims 1 through 3, wherein each participating member can use the website to communicate with and/or obtain advice or instruction from one of multiple participating fitness and health professionals.

8. The website according to claim 4, wherein each participating member can use the website to communicate with and/or obtain advice or instruction from one of multiple participating fitness and health professionals.

9. The website according to claim 5, wherein each participating member can use the website to communicate with and/or obtain advice or instruction from one of multiple participating fitness and health professionals.

10. The website according to claim 6, wherein each participating member can use the website to communicate with and/or obtain advice or instruction from one of multiple participating fitness and health professionals.
